(19) United States
(12) Patent Application Publication
(10) Pub. No.: US 2007/0192472 A1
(43) Pub. Date: Aug. 16, 2007

(54) Download method and transmission device using the same

(75) Inventors: Shingo Tokunaga, Fukuoka (JP); Shigeru Suzuyama, Fukuoka (JP); Daisuke Nagai, Fukuoka (JP); Hiroki Hamachi, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/705,583

(22) Filed: Feb. 13, 2007

(30) Foreign Application Priority Data
Feb. 14, 2006 (JP) 2006-036723

(51) Int. Cl. G06F 15/173

(52) U.S. Cl. 709/223

(57) ABSTRACT

A disclosed download method for downloading software to a transmission device constituting a network includes the steps of: searching for an unused channel between the transmission device and an adjacent transmission device and setting up a cross-connect for the unused channel so as to set up a communication channel for transferring software; transmitting the software stored in a software storage unit to the adjacent transmission device via the communication channel; and receiving software transferred from the adjacent transmission device via the communication channel and storing the software in the software storage unit.

### BACKGROUND OF THE INVENTION

1. Field of the Invention

The present invention generally relates to a download method and a transmission device using the same and more particularly to a download method for downloading software to a transmission device constituting a network and a transmission device using the same.

2. Description of the Related Art

In synchronous digital transmission methods represented by SONET (Synchronous Optical Network) and SDH (Synchronous Digital Hierarchy), a software download function is provided as a method for updating software (including firmware) of each transmission device constituting a network from a remote place, in which an OSI (Open Systems Interconnection) network is constructed and file transfer is performed on the transmission devices.

The OSI network of the SONET/SDH network refers to a communication path used for maintenance of the transmission device separately from main signals. The OSI network is also used so as to set the device using a maintenance command (TL-1) and collect alarms generated in the device, for example.

As a physical layer of the OSI network, generally, DCC (Data Communication Channel) is used, in which D1 to D3 bytes (192 kbps), D4 to D12 bytes (576 kbps) in a section overhead (SOH) of a SONET/SDH frame are used.

FIG. 1 is a diagram showing an example of a structure of the OSI network for maintenance in the synchronous optical network. In FIG. 1, in order to update software, a software file is transferred from a maintenance terminal 1 (OS) where the file is stored to a disk in a transmission device 2 (GNE: Gateway Network Element) connected via LAN or WAN. Then, the file is transferred one by one to transmission devices 3 to 7 requiring update through the use of the OSI network on the SONET/SDH. In accordance with this, software in each transmission device constituting the synchronous optical network is updated.

Patent Document 1 discloses a time slot synthetic circuit disposed on an upper device and a time slot separation circuit disposed on lower devices for downloading of a program from a download device to the plural lower devices via the upper device.

Patent Document 2 discloses a memory disposed on plural transmission devices in a network, the memory storing data on software to be downloaded, and a control unit disposed on the transmission devices, the control unit controlling downloading of data on software to target address locations corresponding to unused time slots in a transmission path for transmitting main signals.

Patent Document 1: Japanese Laid-Open Patent Application No. 2000-357084

Patent Document 2: WO 02/19103 A1

With the advancement of functions and increase of transmission capacity of transmission devices in recent years, software for supplying services to devices and databases for managing setting and structures of the devices have become enlarged. In accordance with this, more labor and time are required so as to maintain the transmission devices constituting a huge synchronous optical network. Further, a load on the GNE is increased while software is being updated and this is problematic in that it may have an influence on services such as alarm collection, redundancy switching, and the like that should originally be performed by the transmission devices.

### SUMMARY OF THE INVENTION

It is a general object of the present invention to provide an improved and useful download method and transmission device using the same in which the above-mentioned problems are eliminated.

A more specific object of the present invention is to provide a download method and transmission device using the same that can reduce time for downloading of software and a load on a specific transmission device at a gateway or a line.

According to an embodiment of the present invention, there is provided a download method for downloading software to a transmission device constituting a network, the download method comprising the steps of: searching for an unused channel between the transmission device and an adjacent transmission device and setting up a cross-connect for the unused channel so as to set up a communication channel for transferring software; transmitting the software stored in a software storage unit to the adjacent transmission device via the communication channel; and receiving software transferred from the adjacent transmission device via the communication channel and storing the software in the software storage unit. Thus, it is possible to reduce time for downloading of software and a load on a specific transmission device at a gateway or a line.

In the above-mentioned download method, the software downloaded from the adjacent transmission device and stored in the software storage unit may be transferred to other adjacent transmission device, and the software may be downloaded to all transmission devices constituting the network.

According to an embodiment of the present invention, there is provided a transmission device for downloading software via a network, the transmission device comprising: a software storage unit storing software; a communication channel setting unit searching for an unused channel between the transmission device and an adjacent transmission device and setting up a cross-connect for the unused channel so as to set up a communication channel for transferring software; a software transmission unit transmitting the software stored in the software storage unit to the adjacent transmission device via the communication channel; and a software reception unit receiving software transferred from the adjacent transmission device via the communication channel and storing the software in the software storage unit. Thus, it is possible to reduce time for downloading of software and a load on a specific transmission device at a gateway or a line.

In the above-mentioned transmission device, the software transmission unit may transfer the software downloaded from the adjacent transmission device and stored in the software storage unit to other adjacent transmission device.

In the above-mentioned transmission device, the device may include: a cross-connect release unit releasing the cross-connect after the software stored in the software storage unit is transmitted to the adjacent transmission device via the communication channel.

In the above-mentioned transmission device, the communication channel setting unit may set up a cross-connect for a protection channel of bidirectional line switch ring so as to set up the communication channel.

In the above-mentioned transmission device, the communication channel setting unit may set up a cross-connect using a plurality of unused channels as a concatenation or a virtual concatenation so as to set up the communication channel.

In the above-mentioned transmission device, when failure is generated in the communication channel, the communication channel setting unit may set up a cross-connect for other unused channel between the transmission device and the adjacent transmission device so as to set up a communication channel.

In the above-mentioned transmission device, the device may include: a transfer rejection unit rejecting transfer of the software from the adjacent transmission device when information on a version of software to be transferred is provided along with a request for setting up the communication channel from the adjacent transmission device and the version information is the same as version information of the software stored in the software storage unit.

In the above-mentioned transmission device, the software may be provided with identification information of a transmission device constituting the network, and the transmission device may include: a software application unit applying the software stored in the software storage unit to the device when identification information of the software stored in the software storage unit corresponds to the identification information of the device.

According to the present invention, it is possible to reduce time for downloading of software and a load on a specific transmission device at a gateway or a line.

Other objects, features and advantage of the present invention will become more apparent from the following detailed description when read in conjunction with the accompanying drawings.

### BRIEF DESCRIPTION OF THE DRAWINGS

FIG. 1 is a diagram showing an example of a structure of an OSI network for maintenance in a synchronous optical network;

FIG. 2 is a block diagram showing a transmission device according to the present invention;

FIG. 3 is a diagram showing a structure of a network using a transmission device according to the present invention;

FIG. 4 is a diagram showing a sequence of setting up a communication channel in a sender of a software file;

FIG. 5 is a diagram showing a sequence of setting up a communication channel in a recipient of a software file;

FIG. 6 is a diagram showing a sequence of file transmission operations in a sender of a software file;

FIG. 7 is a diagram showing a sequence of file transmission operations in a recipient of a software file;

FIG. 8 is a sequence diagram between devices according to a first embodiment of the present invention;

FIG. 9 is a diagram showing cross-connect information held in a management data storage unit;

FIG. 10 is a diagram showing a structure of a packet for control between devices according to the present invention;

FIG. 11 is a diagram showing a structure of a packet for control between devices according to the present invention;

FIG. 12 is a diagram showing a structure of a packet for control between devices according to the present invention;

FIG. 13 is a diagram showing cross-connect information in a management data storage unit according to a second embodiment of the present invention;

FIG. 14 is a diagram showing cross-connect information in a management data storage unit according to a third embodiment of the present invention;

FIG. 15 is a diagram showing cross-connect information in a management data storage unit according to a fourth embodiment of the present invention;

FIG. 16 is a diagram showing attached information included in software to be transferred according to a sixth embodiment of the present invention;

FIG. 17 is a diagram showing transfer availability information held in a software storage unit according to a seventh embodiment of the present invention; and

FIG. 18 is a flowchart showing a process for determining availability of transfer according to the seventh embodiment of the present invention.

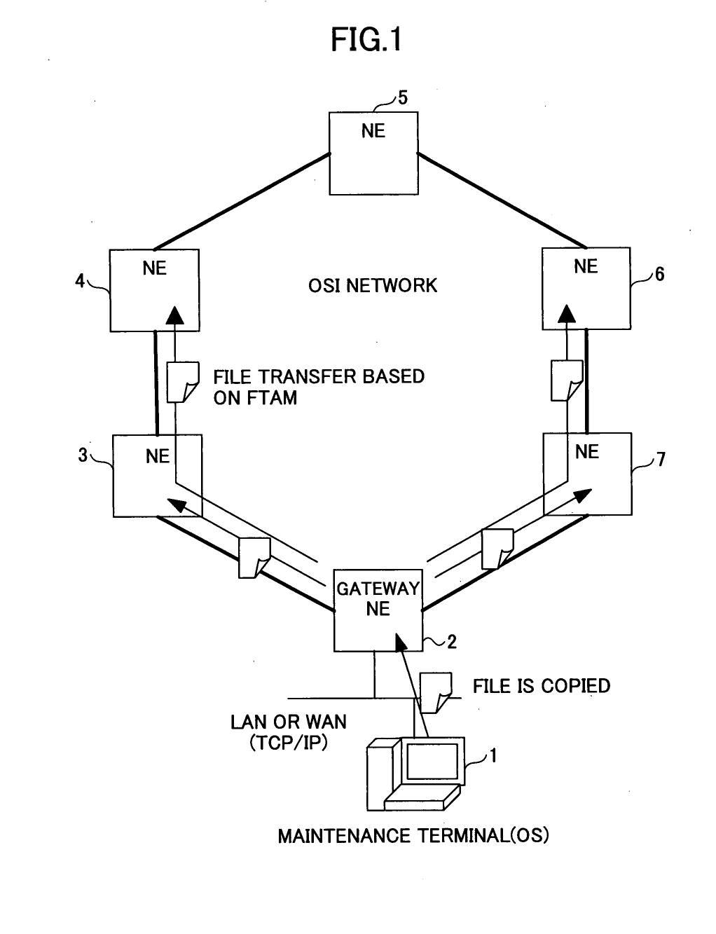

### DETAILED DESCRIPTION OF THE PREFERRED EMBODIMENTS

In the following, embodiments of the present invention will be described with reference to the accompanying drawings.

In the present invention, a transmission device is provided with a unit searching for a channel unused for main signals, a unit converting file transfer data to SONET/SDH signals, and a function for sequentially transferring a file using the unused channel.

### [Structure of Transmission Device]

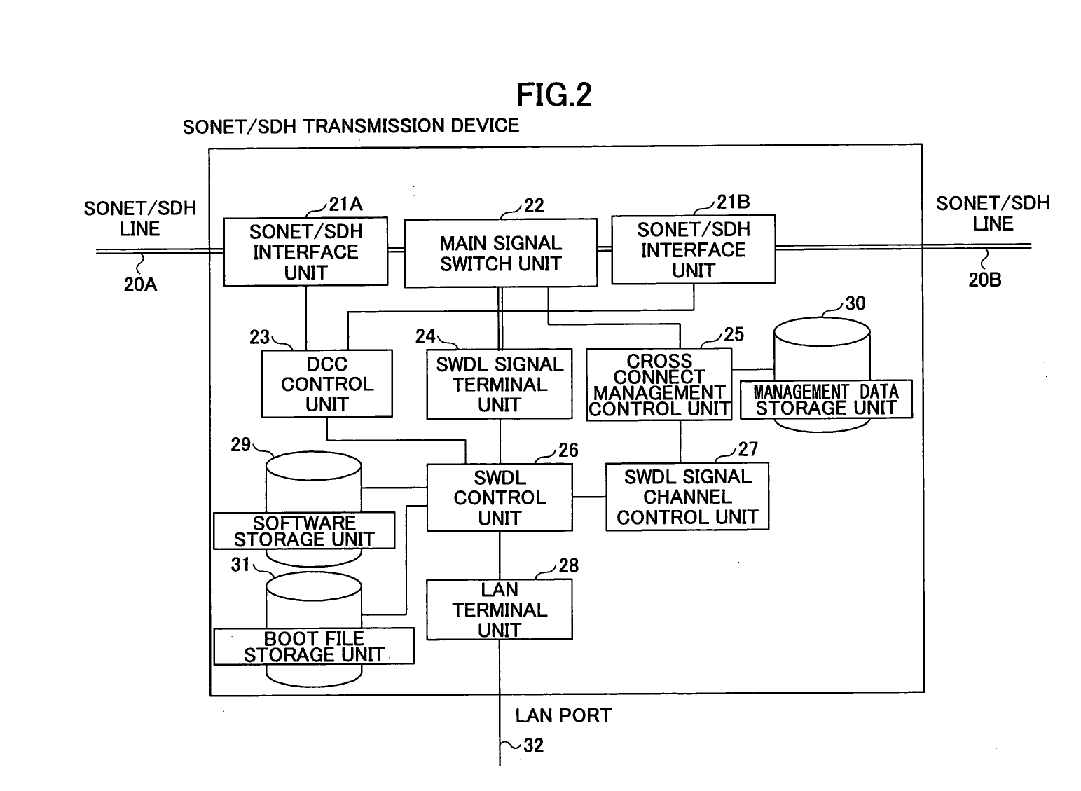

FIG. 2 is a block diagram showing the transmission device according to the present invention. In FIG. 2, SONET/SDH interface units 21A and 21B each terminates a physical line such as optical fiber cables 20A and 20B, coaxial cables, paired wires, or the like connected to the transmission device and transmits the SONET/SDH signals to a main signal switch unit 22.

The main signal switch unit 22 performs switching and add/drop on the signals received from the SONET/SDH interface units 21A and 21B and transmits main signals to the SONET/SDH interface units 21B and 21A on the other end.

A DCC control unit 23 transmits control data to the SONET/SDH interface units 21A and 21B via the OSI protocol so as to exchange data on DCC (Data Communication Channel).

An SWDL (SoftWare DownLoad) signal terminal unit 24 converts data on software which is a transfer subject notified from an SWDL control unit 26 to SONET/SDH signals and transmits the converted signals to the main signal switch unit 22.

A cross-connect management control unit 25 requests the main signal switch unit 22 to change a connection based on user setting or generation of failure. And, the cross-connect management control unit 25 notifies a current main signal connection and a status of usage to an SWDL signal channel control unit 27.

The SWDL control unit 26 stores software received from a LAN port 32 in a software storage unit 29, requests the SWDL signal channel control unit 27 to search for an unused channel upon reception of a request for starting a software transfer, and transmits software on a disk to the SWDL signal terminal unit 24.

The SWDL signal channel control unit 27 receives currently unused channel information from the cross-connect management control unit 25 based on a request for a software transfer of the SWDL control unit 26 and determines a channel to be used for downloading of software.

A LAN terminal unit 28 provides an interface with a terminal where software as an update subject is stored. The software storage unit 29 is a memory unit temporarily storing the software as an update subject.

A management data storage unit 30 stores data on cross-connect information, redundant configuration information, and the like. A boot file storage unit 31 is a memory unit storing software (boot file) used to start up the device.

### [Downloading of Software to GNE]

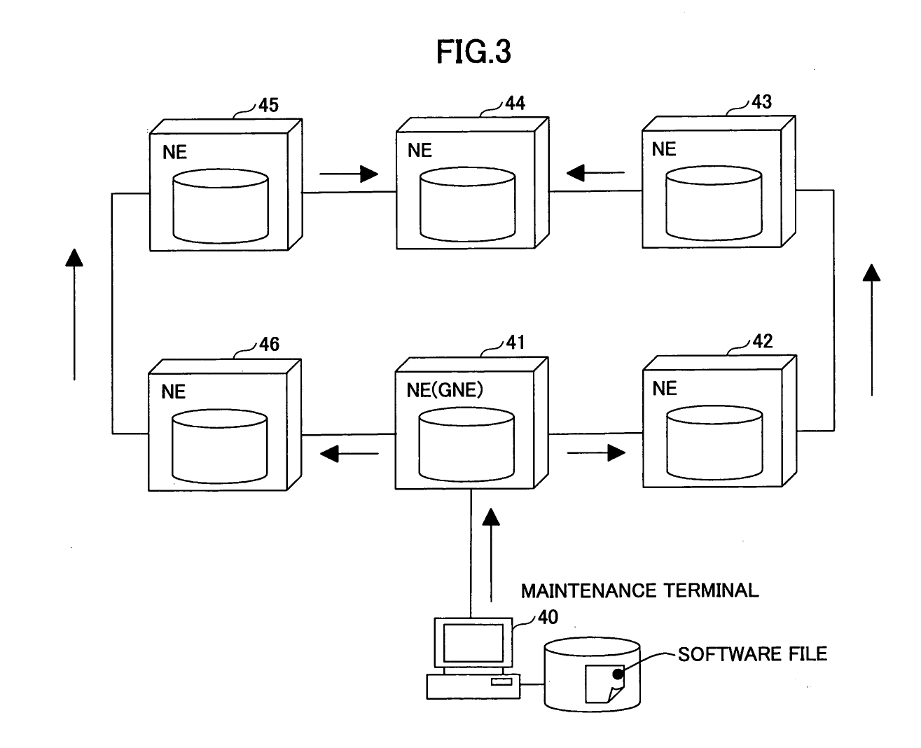

As shown in FIG. 3, a maintenance terminal 40 is assumed to be connected to a transmission device 41 (GNE). The transmission device 41 is connected to the maintenance terminal 40 via the LAN terminal unit 28. The SWDL control unit 26 obtains a software file from the maintenance terminal 40 via the LAN terminal unit 28 and stores the software file in the software storage unit 29.

The SWDL control unit 26 copies the file in the software storage unit 29 to the boot file storage unit 31. When the SWDL control unit 26 reads the latest software file stored in the boot file storage unit 31 and restarts the device, downloading of software in the transmission device 41 is completed.

### [Setting Up a Communication Channel in a Sender of the Software File]

The following describes operations for setting up a communication channel upon transferring the software file from the transmission device 41 to a transmission device 42.

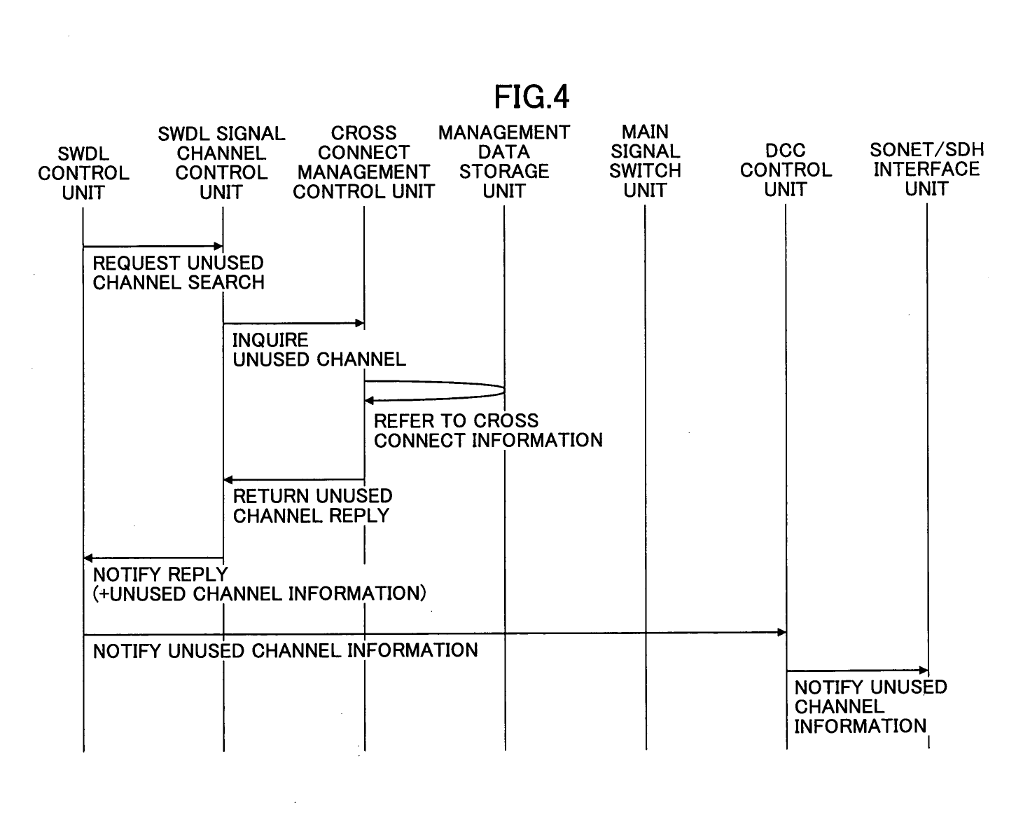

FIG. 4 is a diagram showing a sequence of setting up a communication channel in the sender of the software file. The SWDL control unit 26 of the transmission device 41 requests the SWDL signal channel control unit 27 to search for an unused channel so as to set up a channel for transferring the software file with the transmission device 42.

The SWDL signal channel control unit 27 inquires the cross-connect management control unit 25 whether there is an unused channel. The cross-connect management control unit 25 refers to the cross-connect information stored in the management data storage unit 30 and returns unused channel information to the SWDL control unit 26.

The SWDL control unit 26 of the transmission device 41 transmits the unused channel information from the SONET/SDH interface unit 21B via the DCC control unit 23 in order to notify the information to the adjacent transmission device 42.

### [Setting Up a Communication Channel in a Recipient of the Software File]

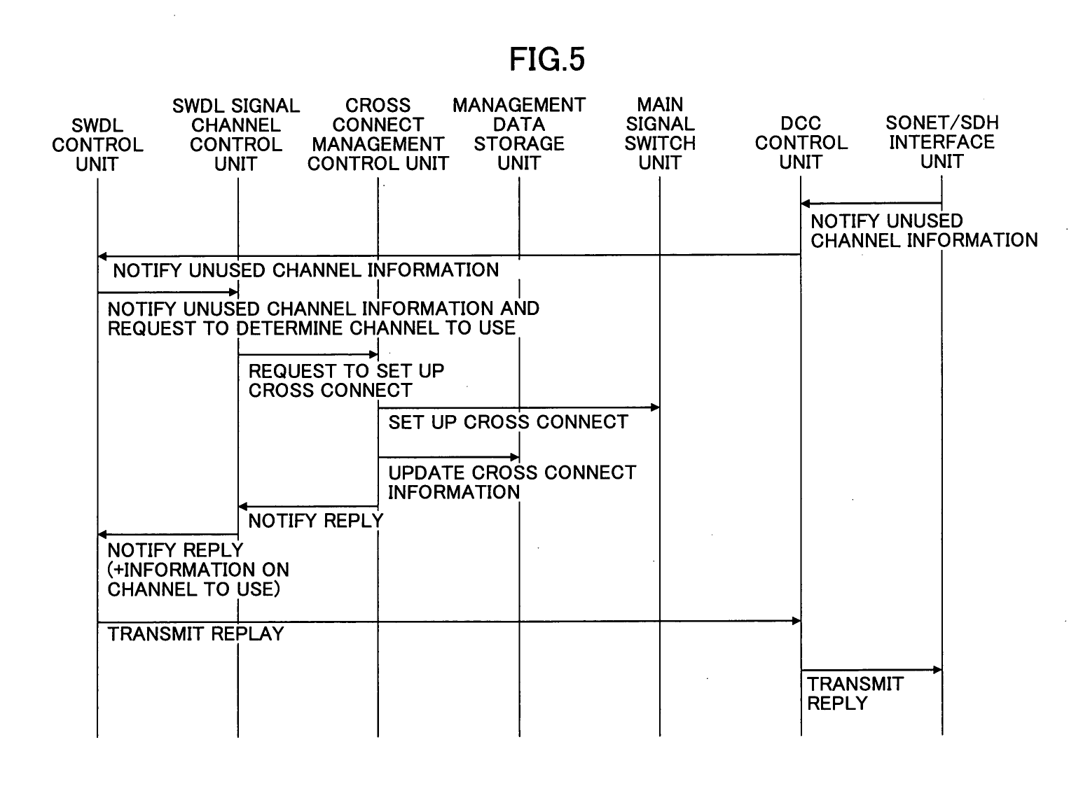

FIG. 5 is a diagram showing a sequence of setting up a communication channel in the recipient of the software file. In the transmission device 42, the unused channel information received from the SONET/SDH interface unit 21A connected to the transmission device 41 is notified to the SWDL control unit 26 via the DCC control unit 23.

The SWDL control unit 26 notifies the unused channel information and a request for determining a channel to use to the SWDL signal channel control unit 27. When there are plural unused channels, a channel to use is determined and then a request for setting up a cross-connect is notified to the cross-connect management control unit 25.

The cross-connect management control unit 25 sets up a cross-connect for the main signal switch unit 22. Then, the cross-connect management control unit 25 stores cross-connect setting information in the management data storage unit 30 and returns a reply to the SWDL control unit 26. The SWDL control unit 26 notifies channel information on the created cross-connect to the DCC control unit 23 and transmits the information from the SONET/SDH interface unit 21A connected to the adjacent transmission device 41.

The transmission device 41 notifies the reply from the transmission device 42 to the SWDL control unit 26 via the SONET/SDH interface unit 21B and the DCC control unit 23. Further, the transmission device 41 sets up a cross-connect for the channel notified from the transmission device 42 via the SWDL signal channel control unit 27 and the cross-connect management control unit 25.

In accordance with the above-mentioned operations, setting up a communication channel for transferring the software file is completed, in which an unused channel between the transmission device 41 and the transmission device 42 is used.

### [File Transmission Operations in the Sender of the Software File]

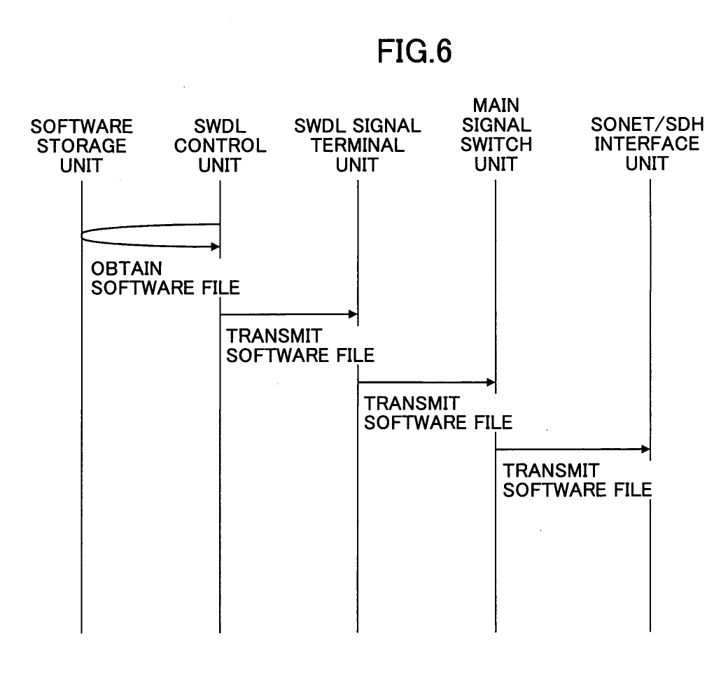

FIG. 6 is a diagram showing a sequence of file transmission operations in the sender of the software file. The SWDL control unit 26 of the transmission device 41 transmits the software file stored in the software storage unit 29 to the SWDL signal terminal unit 24.

Data transmitted from the SWDL signal terminal unit 24 to the main signal switch unit 22 is transmitted to a relevant channel of the SONET/SDH interface unit 21B in accordance with the previously created cross-connect. The software file is transferred to the SONET/SDH interface unit 21A of the adjacent transmission device 42 via the SONET/SDH interface unit 21B.

### [File Reception Operations in the Recipient of the Software File]

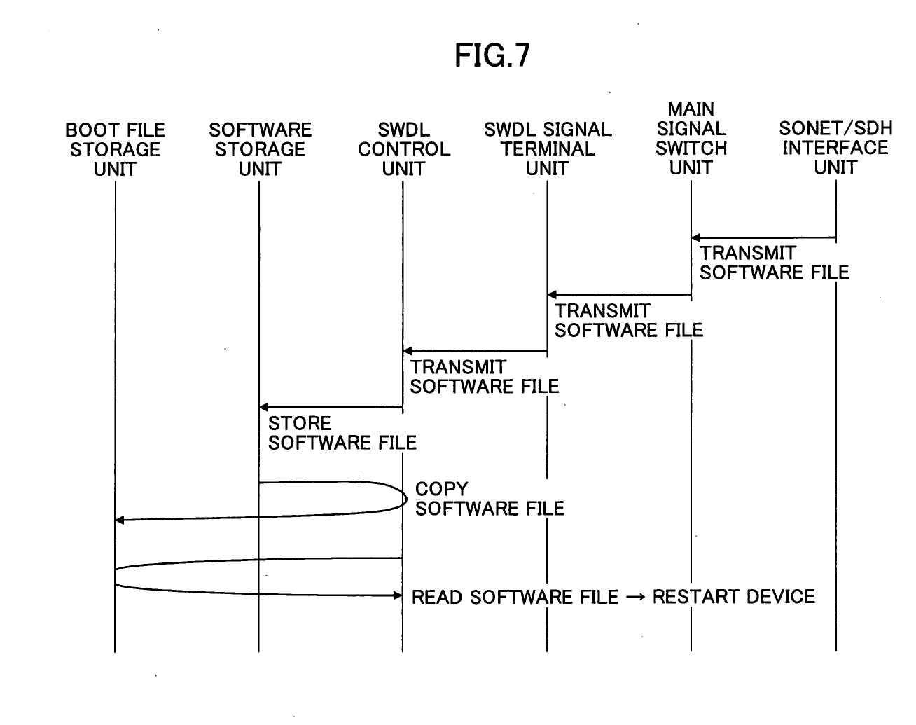

FIG. 7 is a diagram showing a sequence of file transmission operations in the recipient of the software file. The software file received in the SONET/SDH interface unit 21A of the transmission device 42 is transferred to the main signal switch unit 22 and notified to the SWDL signal terminal unit 24 in accordance with the previously created cross-connect.

The software file is transferred from the SWDL signal terminal unit 24 to the SWDL control unit 26 and stored in the software storage unit 29. The SWDL control unit 26 copies the file in the software storage unit 29 to the boot file storage unit 31. When the SWDL control unit 26 reads the latest software file stored in the boot file storage unit 31 and restarts the device, downloading of software in the transmission device 42 is completed.

### [File Transfer to an Adjacent Transmission Device]

In FIG. 3, by performing the same operations as shown in FIGS. 4 to 7 between the transmission device 42 and a transmission device 43, and the transmission device 41 and a transmission device 46, for example, it is possible to update software in all the transmission devices 41 to 46 in the network.

### [Deletion of the Communication Channel for Software File]

The following describes operations for deleting the communication channel between the transmission device 41 and the transmission device 42 after completing the transfer of the software file from the transmission device 41 to the transmission device 42.

The SWDL control unit 26 of the transmission device 42 notifies a request for deleting the cross-connect to the SWDL signal channel control unit 27. The SWDL signal channel control unit 27 requests the cross-connect management control unit 25 to delete the previously created cross-connect.

The cross-connect management control unit 25 requests the main signal switch unit 22 to delete the cross-connect, deletes relevant cross-connect information from the management data storage unit 30, and returns a reply to the SWDL signal channel control unit 27. The SWDL control unit 26 receives the reply from the SWDL signal channel control unit 27, notifies the completion of downloading of software to the DCC control unit 23, and transmits the information from the SONET/SDH interface unit 21A connected to the adjacent transmission device 41 so as to notify the completion to the transmission device 41 using DCC.

The notification of completion received in the SONET/SDH interface unit 21B of the transmission device 41 is notified to the SWDL control unit 26 via the DCC control unit 23. The SWDL control unit 26 notifies a request for deleting the cross-connect to the SWDL signal channel control unit 27.

The SWDL signal channel control unit 27 requests the cross-connect management control unit 25 to delete the previously created cross-connect. The cross-connect management control unit 25 requests the main signal switch unit 22 to release the cross-connect, deletes relevant cross-connect information from the management data storage unit 30, and returns a reply to the SWDL signal channel control unit 27. The SWDL signal channel control unit 27 returns a reply to the SWDL control unit 26.

In this manner, it is possible to delete the cross-connect of the channel for software file transfer.

In addition to the above-mentioned method in which the transmission device 42 independently deletes the cross-connect after downloading of software, it is possible for the transmission device 41 to independently request the transmission device 42 to delete the cross-connect using DCC or a main signal channel.

When DCC is used, a request for deleting the cross-connect is transmitted from the SWDL control unit 26 of the transmission device 41 to the transmission device 42 via the DCC control unit 23 and the SONET/SDH interface units 21A and 21B of the transmission device 41.

When the main signal channel is used, the request for deleting the cross-connect is transmitted from the SWDL control unit 26 of the transmission device 41 to the transmission device 42 via the SWDL signal terminal unit 24, the main signal switch unit 22, and the SONET/SDH interface units 21A and 21B of the transmission device 41.

### [Software Transfer Using a Protection Channel of BLSR]

In the sequence diagram shown in FIG. 4, when the SWDL signal channel control unit 27 selects an arbitrary unused channel, a protection channel of BLSR (Bidirectional Line Switched Ring) is selected. In accordance with this, it is possible to use the protection channel of BLSR as a channel for file transfer.

### [Software Transfer Using Concatenation]

Further, in the sequence diagram shown in FIG. 4, when the SWDL signal channel control unit 27 selects an arbitrary unused channel, if there are plural unused channels, it is possible to set up a channel having a capacity larger than that of a channel for transferring a software file by setting up concatenation or the plural cross-connects as a virtual concatenation.

### [Software Transfer Using DCC When There is No Unused Channel]

Moreover, in the sequence diagram shown in FIG. 4, when the SWDL signal channel control unit 27 selects an arbitrary unused channel, if there is no unused channel, a reply notifying that there is no unused channel is returned to the SWDL control unit 26 without setting up a cross-connect.

The SWDL control unit 26 transfers the software file stored in the software storage unit 29 to the adjacent transmission device 42 via the DCC control unit 23 and the SONET/SDH interface unit 21B.

In the same manner, the transmission device 42 receives the software file in the DCC control unit 23 on DCC from the SONET/SDH interface unit 21A, notifies the SWDL control unit 26, and stores the software file in the software storage unit 29.

In accordance with this, it is possible to transfer the software file using DCC when there is no unused channel.

### [Software Transfer Upon Relieving the Main Signal Channel of BLSR]

While the software file is transferred using the protection channel of BLSR, the SWDL signal terminal unit 24 of the transmission device 41 detects that the protection channel is used to relieve main signals due to failure of the main signal channel. The SWDL signal terminal unit 24 notifies information that the protection channel is unavailable to the SWDL control unit 26.

The SWDL control unit 26 deletes the communication channel for software file that is unavailable and sets up a cross-connect by newly selecting an available channel. In accordance with this, it is possible to transfer a software file through the use of the newly created channel. When there is no unused channel, DCC is used as mentioned above.

### [Software Transfer Upon Failure of a Channel in Use]

In the SWDL signal terminal unit 24 of the transmission device 41, it is possible to transfer the software file through the use of other unused channel or DCC by detecting failure of the channel used for transferring the software file.

### [Rejection Upon Receiving the Request for Transferring Software from Plural Adjacent Transmission Devices]

When the transmission device 44 in FIG. 3 is assumed to receive a request for setting up a communication channel from the transmission device 45 after the completion of downloading of the software file transferred from the transmission device 43, the transmission device 45 notifies the transmission device 44 of channel information and a version of the software file to be transmitted in addition to the channel information.

The SWDL control unit 26 of the transmission device 44 compares the version of the notified software file with the version of the software stored in the software storage unit 29. When the versions are the same, the SWDL control unit 26 returns a transfer rejection reply to the transmission device 45.

When the SWDL control unit 26 of the transmission device 45 receives the transfer rejection reply, the SWDL control unit 26 requests the SWDL signal channel control unit 27 to delete the cross-connect. In accordance with the operation, it is possible to prevent reception of files with the same version in a duplicated manner.

### [Upon Downloading Software to a Specific Device]

In FIG. 3, when the software file is desired to be downloaded to only the transmission device 43, for example, the software file stored in the maintenance terminal 40 is provided with identification information of the transmission device 43 in advance, to which the software file is downloaded.

The SWDL control unit 26 of the transmission device 41 stores the software in the software storage unit 29. Then, the SWDL control unit 26 copies the software to the boot file storage unit 31 only when the software is provided with the identification information of the transmission device 41. When the software is not provided with the identification information of the transmission device 41, the SWDL control unit 26 does not copy the software, so that it is possible to determine whether to apply the software.

In the same manner, the SWDL control unit 26 of the transmission device 42 does not copy the software to the boot file storage unit 31 when the software is not provided with identification information of the transmission device 42.

The transmission device 43 copies the software file to the boot file storage unit 31 since the software file is provided with the identification information of the transmission device 43. In this manner, it is possible to determine whether to apply the software.

### [Confirmation of a Version of Software Upon Starting Up the Device]

In FIG. 3, the transmission device 44 is assumed to be restarted. While the transmission device 44 is being restarted, the software may be downloaded only to other transmission device. Thus, the transmission device 44 transmits an inquiry message to the transmission devices 43 and 45 using DCC from the SWDL control unit 26 upon starting up via the DCC control unit 23 to the SONET/SDH interface units 21A and 21B so as to inquire the versions of the software held in the adjacent transmission devices 43 and 45.

The transmission devices 43 and 45 receive the inquiry message in the SWDL control unit 26 via the SONET/SDH interface units 21A and 21B to the DCC control unit 23. The SWDL control units 26 of the transmission devices 43 and 45 check the version of the software file stored in the software storage unit 29 and transmit a reply message via the DCC control unit 23 to the SONET/SDH interface units 21A and 21B.

The transmission device 44 receives the reply message in the SWDL control unit 26 via the SONET/SDH interface units 21A and 21B to the DCC control unit 23. The version of the software file in the transmission devices 43 and 45 notified from the reply message is compared with the version of the software file stored in the software storage unit 29 of the transmission device 44. When the version of the software file in the transmission devices 43 and 45 is a new version, the transmission device 44 notifies a request for transferring software to the adjacent transmission devices 43 and 45 using DCC.

The software file is transferred from the transmission devices 43 and 45 to the transmission device 44 in the same manner as in FIGS. 4 to 7. In accordance with this, upon starting up the device, it is possible to download the latest software file held in the adjacent devices to the device.

### [Confirmation of Transfer Availability Information]

It is assumed that the software file held in the transmission device 43 is not to be transferred. In addition to the software file, “transfer availability information” is stored in the software storage unit 29 of the transmission device 43. In this case, information indicating “transfer disabled” is assumed to be stored.

In the confirmation of the version of the software, the SWDL control units 26 of the transmission devices 43 and 45 return the “transfer availability information” to the transmission device 44 in addition to the version of the software file stored in the software storage unit 29. In a case where the “transfer availability information” is set to be “transfer disabled” in the SWDL control unit 26 of the transmission device 44 after receiving the reply, the request for transferring a software file is not transmitted to the transmission devices 43 and 45 regardless of the version of the software file. In accordance with this, it is possible to request the adjacent device to transfer the software file only when the “transfer availability information” is set to be “transfer enabled”.

### First Embodiment

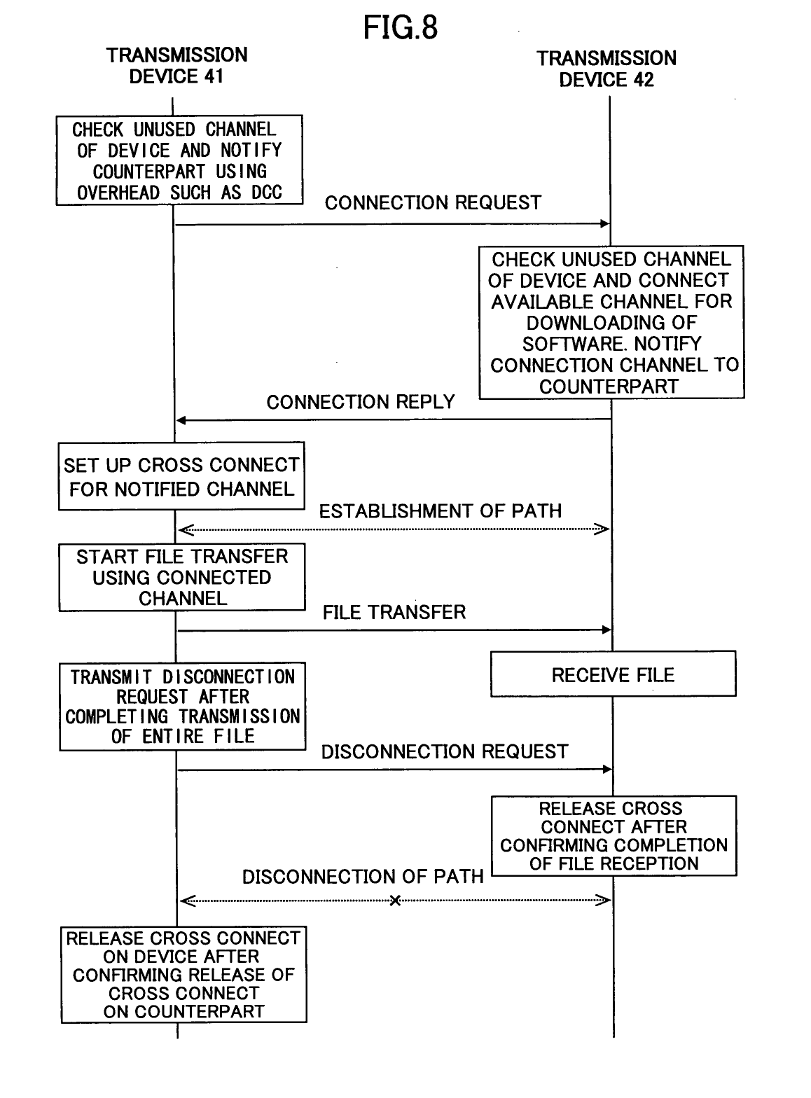

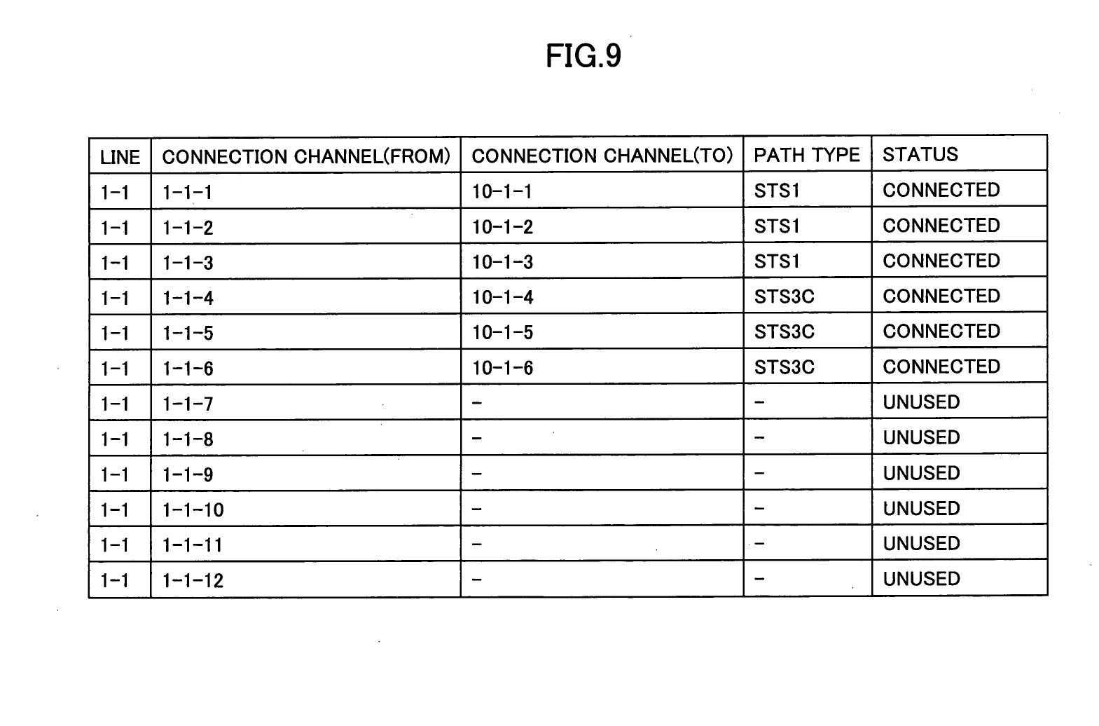

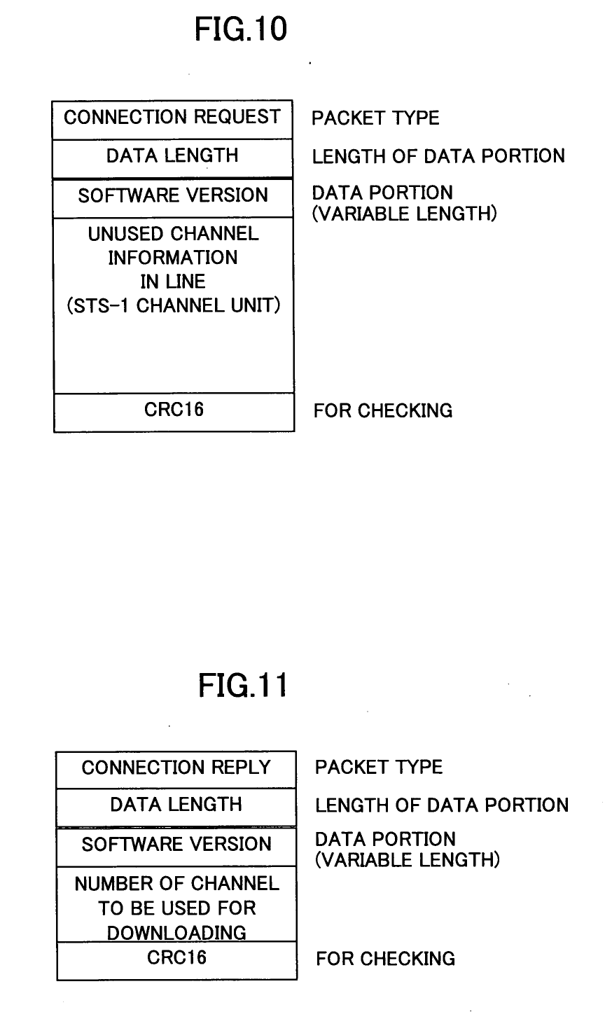

FIG. 8 is a sequence diagram between devices according to a first embodiment of the present invention. FIG. 9 is a diagram showing cross-connect information held in a management data storage unit. And FIGS. 10 to 12 are diagrams showing structures of a packet for control between devices according to the present invention.

The following describes a case where the file is transferred using an STS path on a line OC-n between the sender device (transmission device 41) and the recipient device (transmission device 42), for example.

The transfer is based on the assumption that the transmission device 41 is connected to the maintenance terminal 40 via the LAN terminal unit 28 of the transmission device 41 and the SWDL control unit 26 obtains software to be downloaded from the maintenance terminal 40 and transfers the software to the software storage unit 29 in advance. Further, the software is copied to the boot file storage unit 31 so as to use as software for starting up the device.

In FIG. 8, upon request for starting software transfer, the SWDL control unit 26 of the transmission device 41 confirms whether target software is stored in the software storage unit 29. After the software is confirmed, the SWDL control unit 26 requests the cross-connect management control unit 25 to search for an unused channel via the SWDL signal channel control unit 27.

The cross-connect management control unit 25 extracts cross-connect information from the management data storage unit 30 and extracts a channel that is currently unused from the cross-connect information as shown in FIG. 9. The cross-connect information is delivered to the SWDL control unit 26, where a packet for requesting connection is generated as shown in FIG. 10 in line units such as OC-3, OC-12, OC-48, and the like having DCC, the packet including unused channel information in the line and the file version information. Then, the packet is notified to the DCC control unit 23.

The DCC control unit 23 of the transmission device 41 notifies the packet for requesting connection to the SONET/SDH interface unit 21B terminating the specified line, the SONET/SDH interface unit 21B places the packet on channel D (DCC) on the SONET/SDH and notifies the packet to the adjacent recipient device (transmission device 42).

The transmission device 42 takes out the packet for requesting connection placed on channel D from the SONET/SDH interface unit 21A and notifies the packet to the DCC control unit 23. The DCC control unit 23 transfers information collected from each line to the SWDL control unit 26. The SWDL control unit 26 checks whether software with the same version has already been stored in the software storage unit 29. When the software with the same version has already been stored, the packet for requesting connection is discarded.

When such software is not stored, the version of the notified software and the unused channel information in each line is compared with a status of the cross-connect of the transmission device 42 obtained from the management data storage unit 30 via the SWDL signal channel control unit 27 and the cross-connect management control unit 25. Based on this comparison, a channel to be used is determined. Examples of this determination method include a method for selecting a channel having a wider bandwidth.

After the channel to be used is determined, the SWDL signal channel control unit 27 requests the cross-connect management control unit 25 to set up a cross-connect for the specified channel. The cross-connect management control unit 25 sets I/O of the main signal switch unit 22 and sets up a cross-connect between a relevant channel of the SONET/SDH interface unit 21A storing the specified channel and the SWDL signal terminal unit 24.

Further, the SWDL signal channel control unit 27 notifies the channel created for downloading software to the SWDL control unit 26. In the SWDL control unit 26, a connection reply packet as shown in FIG. 11 including information on the connection channel is generated and the connection reply packet is notified the sender device (transmission device 41) through the DCC line storing the channel via the DCC control unit 23 and the SONET/SDH interface unit 21A.

The sender device (transmission device 41) receives the connection reply packet and the connection reply packet is transmitted to the SWDL control unit 26 via the SONET/SDH interface unit 21B and the DCC control unit 23. Then, the information on the channel to be used is extracted from the connection reply packet in the SWDL control unit 26 and the SWDL control unit 26 requests the cross-connect management control unit 25 to set up a cross-connect via the SWDL signal channel control unit 27.

The cross-connect management control unit 25 stores cross-connect information in the management data storage unit 30. In addition, the cross-connect management control unit 25 operates I/O of the main signal switch unit 22 and sets up a cross-connect between the SONET/SDH interface unit 21B in which the specified channel is stored and the SWDL signal terminal unit 24. When the cross-connect is normally created, completion of connection is notified to the SWDL control unit 26.

The SWDL control unit 26 receives the notification of completion of connection, extracts data on subject software from the software storage unit 29, and transmits the data to the SWDL signal terminal unit 24. The SWDL signal terminal unit 24 notifies the data to the facing recipient device (transmission device 42) through the channel connected in the above-mentioned operations via the main signal switch unit 22 and the SONET/SDH interface unit 21B.

The recipient device (transmission device 42) receives the software data and the software data is transmitted to the SWDL signal terminal unit 24 via the SONET/SDH interface unit 21A and the main signal switch unit 22. Methods for correcting errors upon transferring the file, retransmission upon generation of errors, and the like are based on file transfer protocols such as the OSI-FTAM protocol, the FTP protocol in TCP/IP, and the like. The received software data is stored in the software storage unit 29 via the SWDL control unit 26.

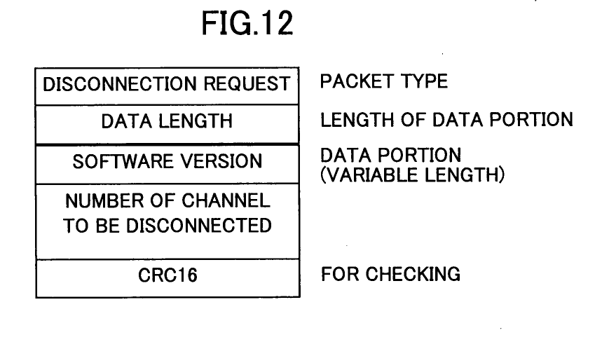

When the SWDL control unit 26 of the sender device (transmission device 41) confirms completion of transfer of all the target files, a packet for requesting disconnection as shown in FIG. 12 is generated and the packet is notified to the recipient device (transmission device 42) via the SWDL signal terminal unit 24, the main signal switch unit 22, and the SONET/SDH interface unit 21B.

The recipient device (transmission device 42) receives the packet for requesting disconnection and notifies relevant information to the SWDL control unit 26 via the SONET/SDH interface unit 21A, the main signal switch unit 22, and the SWDL signal terminal unit 24.

The SWDL control unit 26 confirms the completion of an entire process for transferring the software performed with the use of the channel, and then the SWDL control unit 26 requests the SWDL signal channel control unit 27 to disconnect the cross-connect of the channel.

The SWDL signal channel control unit 27 requests the cross-connect management control unit 25 to disconnect the cross-connect and the cross-connect management control unit 25 operates the I/O of the main signal switch unit 22 so as to release the cross-connect created between the SONET/SDH interface unit 21A and the SWDL signal terminal unit 24. This completes the entire software reception, so that the software is copied to the boot file storage unit 31 from the software storage unit 29.

The sender device (transmission device 41) confirms the release of the cross-connect of the recipient device (transmission device 42) when the SWDL signal terminal unit 24 of the transmission device 42 receives alarms such as “UNEQ-P” and the like.

Thereafter, in ordr to release the cross-connect of the sender device (transmission device 41), the release of the cross-connect is notified to the SWDL signal channel control unit 27 via the SWDL control unit 26 and the cross-connect management control unit 25 is requested to release the cross-connect. The cross-connect management control unit 25 operates the I/O of the main signal switch unit 22 so as to release the cross-connect created between the SONET/SDH interface unit 21B and the SWDL signal terminal unit 24.

### Second Embodiment

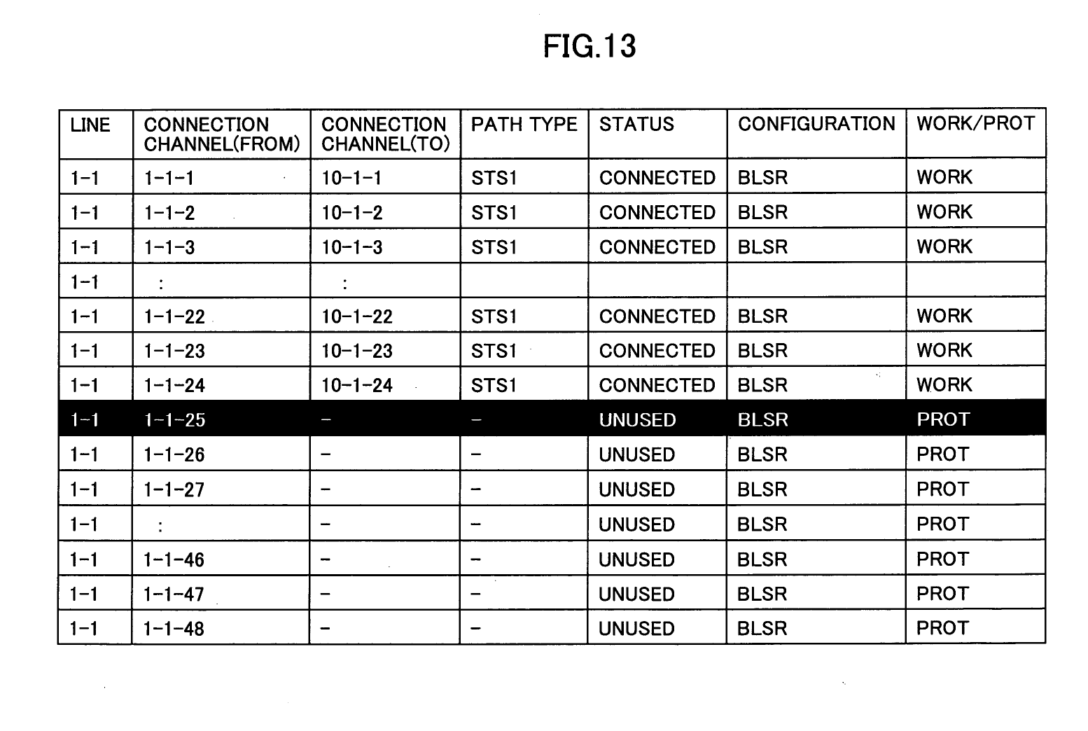

FIG. 13 is a diagram showing cross-connect information in the management data storage unit 30 according to a second embodiment of the present invention. The following describes a case where the file is transferred using the protection line of BLSR between the devices. Each transmission device holds information on a cross-connect setting status and setting (enabled/disabled) of the BLSR configuration.

The cross-connect management control unit 25 of the sender device (transmission device 41) determines whether a redundant configuration is built in accordance with BLSR using the information. When the BLSR configuration is built, the cross connect management control unit 25 searches for an unused protection line of BLSR. When the unused protection line is detected as shown in a highlighted text in FIG. 13, the sender device (transmission device 41) sets up a cross-connect in the procedure described in the first embodiment and transfers the file.

### Third Embodiment

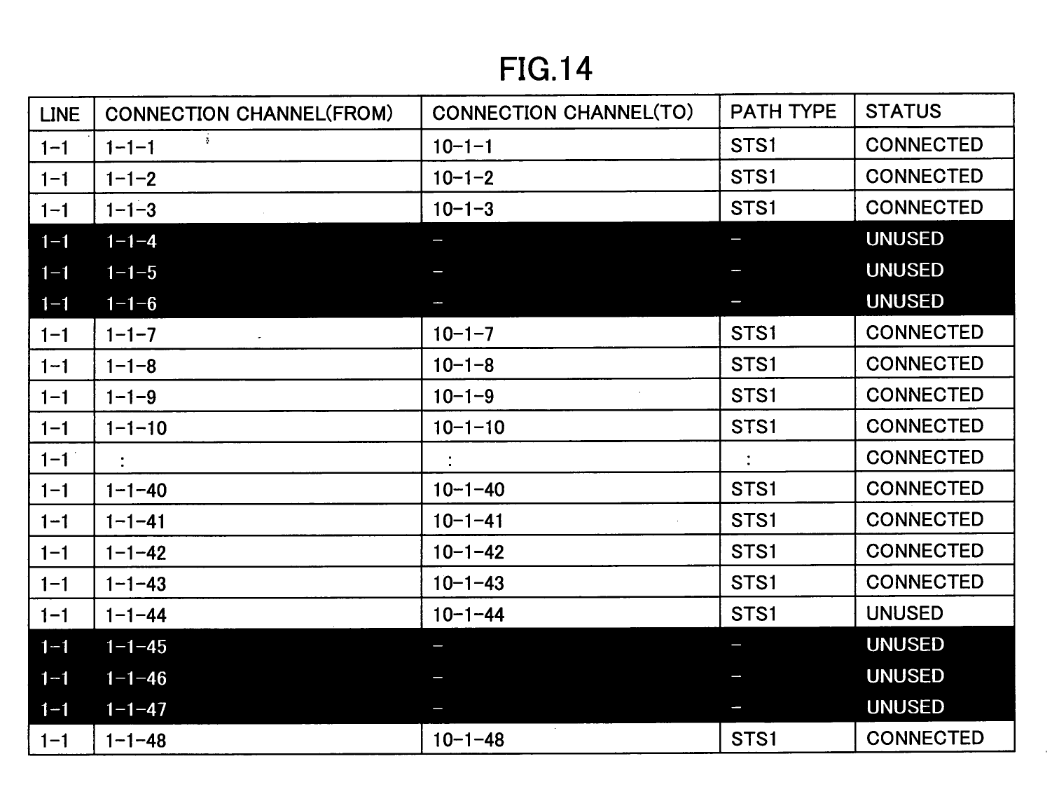

FIG. 14 is a diagram showing cross-connect information in the management data storage unit 30 according to a third embodiment of the present invention. In this case, when there are plural unused channels, file transfer is performed using the plural channels as a virtual concatenation. Each transmission device holds the cross-connect information stored in the management data storage unit 30, the cross-connect information managing a status of cross-connect setting as shown in FIG. 14.

The cross-connect management control unit 25 of the sender device (transmission device 41) uses the cross-connect information held in the management data storage unit 30 and searches for an unused channel as shown in a highlighted text in FIG. 14. As shown in FIG. 14, when plural channels 1-1-4 to 1-1-6 and channels 1-1-45 to 1-1-47 are unused, information on these unused channels is included in the packet for requesting connection as shown in FIG. 10 and notified to the recipient device (transmission device 42).

The recipient device (transmission device 42) extracts the unused channel information from the received packet for requesting connection and notifies the SWDL signal channel control unit 27. Then, the SWDL signal channel control unit 27 confirms the channels 1-1-4 to 1-1-6 and channels 1-1-45 to 1-1-47 as plural available channels and notifies the cross-connect management control unit 25 of a request for setting up a cross-connect using all the channels as a virtual concatenation of STS1-6V.

The cross-connect management control unit 25 sets up the virtual concatenation of STS1-6V between the SONET/SDH interface unit 21A and the SWDL signal terminal unit 24 by operating the I/O of the main signal switch unit 22. After the setting up is completed, a connection reply packet is notified to the sender device (transmission device 41).

The sender device (transmission device 41) receives the connection reply packet and sets up a cross-connect as a virtual concatenation in the same manner. And the sender device performs file transfer using the creased channel.

### Fourth Embodiment

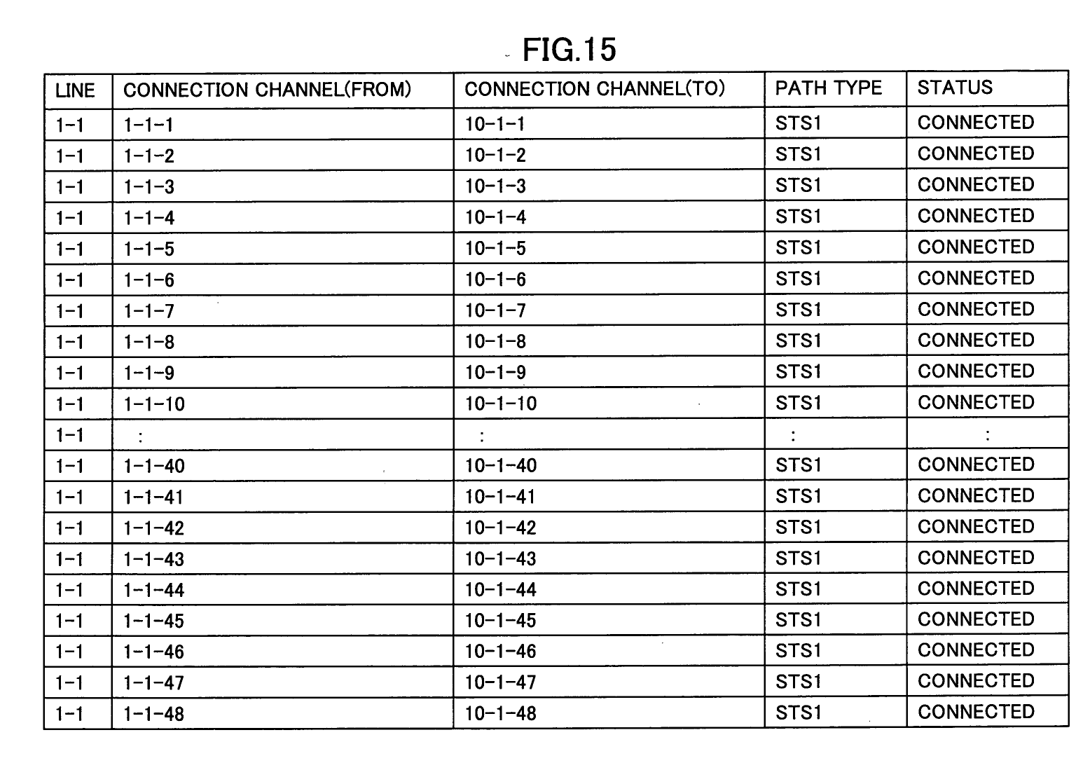

FIG. 15 is a diagram showing cross-connect information in the management data storage unit 30 according to a fourth embodiment of the present invention. The following describes a case where there is no unused channel. The cross-connect management control unit 25 of the sender device (transmission device 41) searches for an unused channel from the cross-connect information. When no unused channel is found as a result of the search, the SWDL signal channel control unit 27 notifies the result to the SWDL control unit 26 and the SWDL control unit 26 notifies the recipient device (transmission device 42) via the DCC control unit 23 and the SONET/SDH interface unit 21B so as to transfer software using DCC.

The recipient device (transmission device 42) receives the notification in the SWDL control unit 26 via the SONET/SDH interface unit 21A and the DCC control unit 23. The SWDL control unit 26 performs setting such that software data received in the DCC control unit 23 is transferred to the software storage unit 29. And, the SWDL control unit 26 returns a reply to the sender device (transmission device 41) via the DCC control unit 23 and the SONET/SDH interface unit 21A.

The SWDL control unit 26 of the sender device (transmission device 41) receives the reply and transmits the software data stored in the software storage unit 29 to the DCC control unit 23, so that the file is transmitted to the recipient device (transmission device 42) using DCC.

### Fifth Embodiment

The following describes a relief process when a line used for transferring the software file becomes unavailable. When the protection channel of BLSR used as a channel for file transfer becomes unavailable so as to relieve the main signal channel of BLSR, the cross-connect management control unit 25 of the sender device (transmission device 41) deletes the channel used for file transfer in the procedure described in the first embodiment and searches for an unused channel again.

When the unused channel is detected, file transfer is performed in the procedure described in the second embodiment or the third embodiment. When no unused channel is found, file transfer is performed in the procedure described in the fourth embodiment.

In addition, when failure is detected in the channel used as a channel for file transfer, file transfer is performed in the same procedure.

### Sixth Embodiment

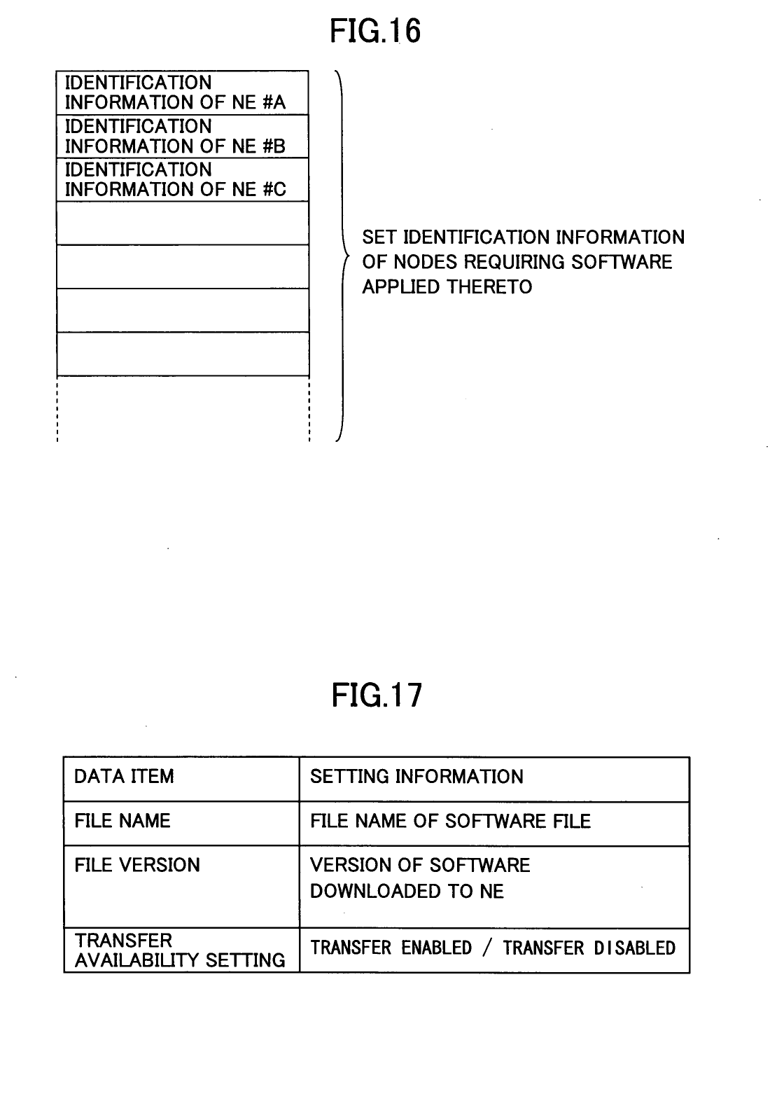

FIG. 16 is a diagram showing attached information included in software to be transferred according to a sixth embodiment of the present invention. A complete set of a software file to be transferred to each transmission device includes a list of application subject nodes attached thereto as shown in FIG. 16 and used as information for managing transmission devices to which the software file can be downloaded.

The SWDL control unit 26 of the recipient (transmission device 42) stores the received software file and the list of application subject nodes as attached information in the software storage unit 29. Then, the SWDL control unit 26 confirms whether identification information of the device is registered in the list of application subject nodes included in the software file stored in the software storage unit 29.

When the identification information of the device is registered in the list of application subject nodes, the software is copied to the boot file storage unit 31 from the software storage unit 29. When the identification information of the device is not registered, the software is not copied to the boot file storage unit 31. In accordance with this it is possible not to apply the transferred software to the device.

### Seventh Embodiment

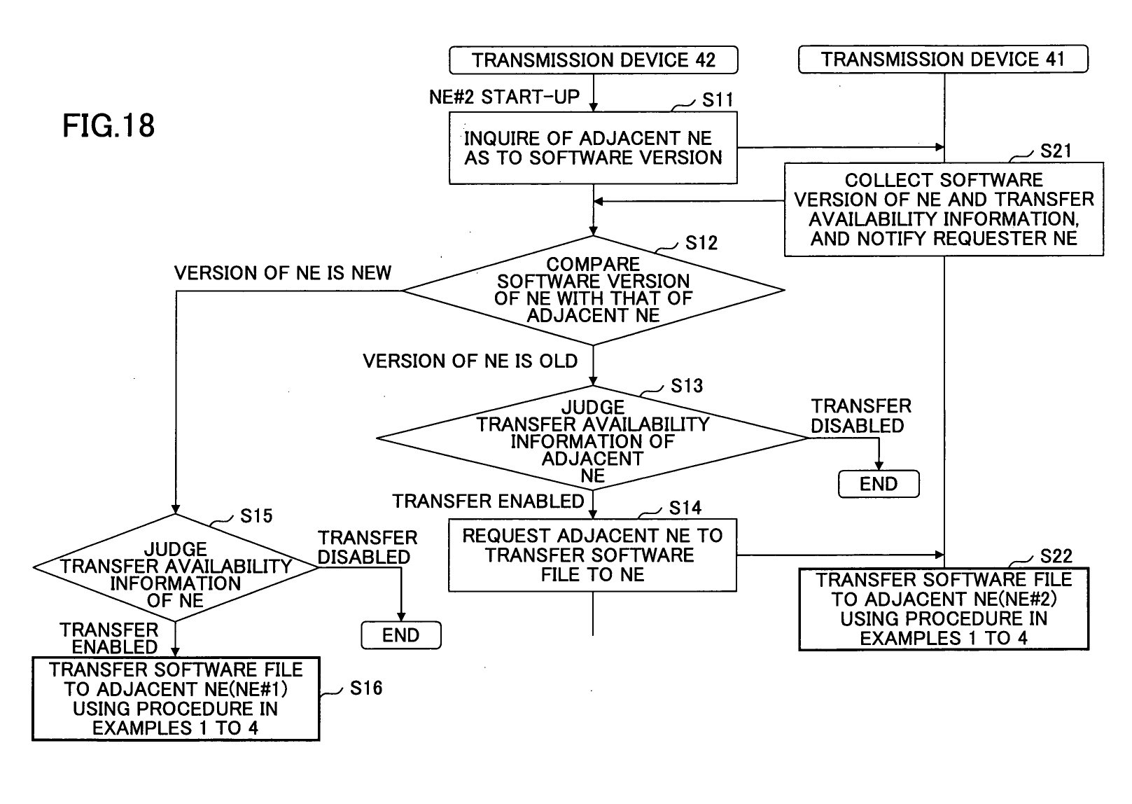

FIG. 17 is a diagram showing transfer availability information held in the software storage unit 29 according to a seventh embodiment of the present invention. FIG. 18 is a flowchart showing a process for determining availability of transfer according to the seventh embodiment of the present invention. The following describes an example of a process for updating the software file upon starting up a node.

The software storage unit 29 of each transmission device holds the process for determining availability of transfer shown in FIG. 18.

First, the following describes operations upon starting up the transmission device 42 to which software having an old version relative to the transmission device 41 is downloaded. After the start-up of the transmission device 42, the SWDL control unit 26 inquires of the transmission device 41 as to the version of the software using DCC (step S11).

The SWDL control unit 26 of the transmission device 41 receives the inquiry as to the version of the software from the transmission device 42. Then, the SWDL control unit 26 collects information on the version of the software and the transfer availability information stored in the software storage unit 29 and notifies the collected information to the transmission device 42 using DCC (step S21).

The SWDL control unit 26 of the transmission device 42 receives the reply from the transmission device 41 and compares the version of the software obtained from the transmission device 41 with the version of the software stored in the software storage unit 29 of the transmission device 42 (step S12). When the version of the software of the transmission device 42 is determined to be old as a result of the comparison of both versions of software, the SWDL control unit 26 judges setting of transfer availability in the transfer availability information notified from the transmission device 41 (step S13). When “transfer enabled” is set, the packet requesting for connection is transmitted to the transmission device 41 using DCC (step S14) and file transfer is attempted. Thereafter, the software is downloaded in the procedure shown in FIG. 8.

On the other hand, the following describes operations as an opposite case upon starting up the transmission device 42 having a new version relative to the transmission device 41. After the start-up of the transmission device 42, the SWDL control unit 26 inquires of the transmission device 41 as to the version of the software using DCC (step S11).

The SWDL control unit 26 of the transmission device 41 receives the inquiry as to the version of the software from the transmission device 42. Then, the SWDL control unit 26 collects information on the version of the software and the transfer availability information stored in the software storage unit 29 and notifies the collected information to the transmission device 42 using DCC (step S21).

The SWDL control unit 26 of the transmission device 42 receives the reply from the transmission device 41 and compares the version of the software obtained from the transmission device 41 with the version of the software stored in the software storage unit 29 of the transmission device 42 (step S12).

When the version of the software of the transmission device 42 is determined to be new as a result of the comparison of both versions of software, the SWDL control unit 26 judges setting of availability of transfer in the transfer availability information of the transmission device 42 stored in the software storage unit 29 (step S15) When “transfer enabled” is set, the packet requesting for connection is transmitted to the transmission device 41 using DCC (step S16). Thereafter, the software file is transferred from the transmission device 42 to the transmission device 41 in the procedure shown in FIG. 8.

According to the present invention, the following effects are obtained. Firstly, in a software download method for SONET/SDH transmission devices, an unused and wide bandwidth channel for main signals is used as a channel for file transfer, so that it is possible to achieve high-speed downloading of software to each transmission device. Further, the file is sequentially transferred between the transmission devices, so that it is possible to prevent an excessive load on a specific transmission device or channel, thereby stabilizing the entire network.

Secondly, when there is no unused main signal channel, a protection line of BLSR in which signals are not transmitted in a normal status is used, so that it is possible to achieve high-speed downloading of software and stabilize the entire network.

Thirdly, when there are plural unused main signal channels, these channels are used collectively, so that it is possible to achieve further high-speed downloading of software.

Fourthly, even when there is no unused main signal channel or protection channel, the downloading method is switched to a conventional method in which DCC provided in SONET/SDH is used, so that it is possible to perform downloading of software.

Fifthly, while downloading of software is performed using the unused main signal channel or the protection channel, when the channel in use becomes unavailable, the channel is switched to other channel, so that it is possible to perform the downloading of software without interruption.

Sixthly, software to be transferred is provided with information on availability of application of the software, so that it is possible to apply the new software only to a specific device as a target of software update in accordance with a type or a structure of the device.

Seventhly, when the transmission device is restarted, the device inquires of an adjacent device as to the latest version of software, so that even if the device is automatically stopped when the adjacent device transmits a request for transferring software, it is possible to obtain the latest software upon starting up the device thereafter.

The software storage unit 29 corresponds to a software storage unit, the SWDL control unit 26 and the SWDL signal channel control unit 27 correspond to a communication channel setting unit, the SWDL signal terminal unit 24 and the SWDL control unit 26 correspond to a software transmission unit, the SWDL signal terminal unit 24 and the SWDL control unit 26 correspond to a software reception unit, the SWDL control unit 26 and the SWDL signal channel control unit 27 correspond to a cross-connect release unit, the SWDL control unit 26 corresponds to a transfer rejection unit, the SWDL control unit 26 and the boot file storage unit 31 correspond to a software application unit, and the SWDL control unit 26 corresponds to a transfer request unit.

The present invention is not limited to the specifically disclosed embodiment, and variations and modifications may be made without departing from the scope of the present invention.

The present application is based on Japanese priority application No. 2006-036723 filed Feb. 14, 2006, the entire contents of which are hereby incorporated herein by reference.

What is claimed is:

1. A download method for downloading software to a transmission device constituting a network, the download method comprising the steps of:
searching for an unused channel between the transmission device and an adjacent transmission device and setting up a cross-connect for the unused channel so as to set up a communication channel for transferring software;
transmitting the software stored in a software storage unit to the adjacent transmission device via the communication channel; and
receiving software transferred from the adjacent transmission device via the communication channel and storing the software in the software storage unit.

2. The download method according to claim 1, wherein
the software downloaded from the adjacent transmission device and stored in the software storage unit is transferred to other adjacent transmission device, and
the software is downloaded to all transmission devices constituting the network.

3. A transmission device for downloading software via a network, the transmission device comprising:
a software storage unit storing software;
a communication channel setting unit searching for an unused channel between the transmission device and an adjacent transmission device and setting up a cross-connect for the unused channel so as to set up a communication channel for transferring software;
a software transmission unit transmitting the software stored in the software storage unit to the adjacent transmission device via the communication channel; and
a software reception unit receiving software transferred from the adjacent transmission device via the communication channel and storing the software in the software storage unit.

4. The transmission device according to claim 3, wherein
the software transmission unit transfers the software downloaded from the adjacent transmission device and stored in the software storage unit to other adjacent transmission device.

5. The transmission device according to claim 3, including:
a cross-connect release unit releasing the cross-connect after the software stored in the software storage unit is transmitted to the adjacent transmission device via the communication channel.

6. The transmission device according to claim 3, wherein
the communication channel setting unit sets up a cross-connect for a protection channel of bidirectional line switch ring so as to set up the communication channel.

7. The transmission device according to claim 3, wherein
the communication channel setting unit sets up a cross-connect using a plurality of unused channels as a concatenation or a virtual concatenation so as to set up the communication channel.

8. The transmission device according to claim 3, wherein
when failure is generated in the communication channel, the communication channel setting unit sets up a cross-connect for other unused channel between the transmission device and the adjacent transmission device so as to set up a communication channel.

9. The transmission device according to claim 4, including:
a transfer rejection unit rejecting transfer of the software from the adjacent transmission device when information on a version of software to be transferred is provided along with a request for setting up the communication channel from the adjacent transmission device and the version information is the same as version information of the software stored in the software storage unit.

10. The transmission device according to claim 4, wherein
the software is provided with identification information of a transmission device constituting the network, and
the transmission device includes:
a software application unit applying the software stored in the software storage unit to the device when identification information of the software stored in the software storage unit corresponds to the identification information of the device.

11. The transmission device according to claim 4, wherein
the adjacent transmission device stores information on a version of the software along with the software, and
the transmission device includes:
a transfer request unit inquiring of the adjacent transmission device as to the version information of the software stored in the adjacent transmission device upon start-up and requesting the adjacent transmission device to transfer the software when the version information of the software stored in the adjacent transmission device is new relative to version information of the software stored in the device.

12. The transmission device according to claim 11, wherein
the adjacent transmission device further stores transfer availability information, and
the transfer request unit inquires of the adjacent transmission device as to the transfer availability information in addition to the version information of the software stored in the adjacent transmission device upon start-up and, only when transfer is enabled in the transfer availability information, requests the adjacent transmission device to transfer the software.
